(19) United States
(12) Patent Application Publication
(10) Pub. No.: US 2009/0008828 A1
(43) Pub. Date: Jan. 8, 2009

(54) METHOD AND APPARATUS FOR THE MANUFACTURE OF PRE-INKED RUBBER STAMPS

(75) Inventor: Leo Henn Humal, Tartu (EE)

Correspondence Address: LEO-HENN HUMAL, RIIA 24, PK 86, TARTU, 51002, EE

(73) Assignee: Leo Henn Hunal, Tartu (EE)

(21) Appl. No.: 12/146,737

(22) Filed: Jun. 26, 2008

(30) Foreign Application Priority Data
Jul. 4, 2007 (EE) P20070035

(51) Int. Cl. B29C 35/08; H05B 7/18

(52) U.S. Cl. 264/413; 219/383

(57) ABSTRACT

Method of manufacturing of the pre-inked rubber stamp from thermo-plastic material, based on selective closing of surface pores of raw printing plate (27) from porous thermo-plastic material by selective flash irradiation, comprising of preparing of transparent thin sheet material (30) with non-transparent original pattern of necessary stamp print-out, pressing raw printing plate, covered with the said transparent sheet with original pattern, against flat transparent cover (2) of a flash light source, exposing the said raw printing plate through the said transparent sheet by several flashes, the raw printing plate (27) together with the thin sheet (30) with original pattern is transposed along the transparent cover (2) of the flash light source between the flash expositions, a non-transparent cover (32) with opening for exposing and markings (33) is used. Flash light source has a controller that automatically decreases the successive flash energy to compensate the local temperature rising of the said transparent cover (2).

### TECHNICAL FIELD

The present invention belongs to the sphere of printing industry, more specifically to the manufacture of pre-inked rubber stamps.

### BACKGROUND OF THE ART

In the field of manufacturing pre-inked rubber stamps micro-porous thermo-plastic materials have been used, because their surface pores can be closed by heating and simultaneous compressing, in this way producing areas, which are impermeable to stamp ink, and can therefore serve as non-printing elements of a rubber stamps printing surface. By compressing a blank printing plate and simultaneously selectively heating it's surface elements, which correspond to the non-printing elements of the required stamp typesetting pattern, a printing plate is produced which, after it has been filled with ink and mounted into a stamp mount forms a rubber stamp capable of producing a large number (tens of thousands) of imprints with no need for an ink-pad.

For selective heating a process is invented, where the selective heating is performed by high energy flash light exposure and the printing elements are screened from the flashlight by dark areas of the original pattern (U.S. Pat. No. 5,858,298, Humal 1995). In general, flash exposing machines are used, where the entire plank printing plate is compressed and exposed simultaneously (EP 0 810 100, Brother 1997), that requires considerably high flash energy and pressing force. Stamp making assembly is invited (U.S. Pat. No. 5,873,308, Brother 1999), where the light source moves along the area to be exposed, whereas the total surface of stamp face member is compressed. This assembly needs mechanical design with moving elements and requires considerably high force for compressing the total area of stamp face member. Method and device are suggested (U.S. Pat. No. 4,323,775, Riso 1982) where successive portions are sequentially clamped between a pressure plate and a light transmitting plate, and are irradiated with electromagnetic radiation through the light transmitting plate in the clamped condition. The described method is used for thermographic duplication, but for making of pre-inked rubber stamps from micro-porous thermoplastic material method of sequential transposing the blank printing plate over the flash light source has not been described. The described device has quite complicated mechanical design in order to transport and sequentially clamp the material to be exposed. Moreover, with this method, the problem is, that successive flashing heats up the light transmitting plate end thus the thermal conditions for every next flash exposition are different. If the flash energy is adjusted to be optimal for the first exposition, at the next expositions the printing plate's material is overheated and small printing elements can disappear. Flash exposing units with thermal pick-up are known, where flash energy is regulated depending on the measured temperature. But, the thermal pick-up cannot measure the real temperature of the contacting surface between the light transmitting plate and the micro-porous thermo-plastic material for stamp.

### SUMMARY OF THE INVENTION

First, present invention provides method of manufacturing printing plates of pre-inked stamp from thermo-plastic material, where raw printing plate together with the thin sheet with original pattern is transposed along the transparent cover of the flash light source between the flash expositions. Further, it provides a non-transparent cover with opening for exposing that screens the flashlight from operator's eyes and is supplied with markings that enable adequate transposing of the row printing plate. The method is accomplished by using apparatus provided by the present invention, comprising of one or several gas filled flashtubes, covered by flat transparent cover, flash capacitor(s), trigger circuits, charging circuit and controller, the said flashtube(s) automatically perform(s) series flashing at certain interval, where the controller automatically decreases the successive flash energy to compensate the local temperature rising of the said transparent cover. The upper surface of the said flat transparent cover is provided with integral non-transparent mask with transparent window above the flash-lamp(s), that determines the scope of exposable area for every single flash.

### BRIEF DESCRIPTION OF THE DRAWINGS

FIG. 1 is an isometric view, partly cut away, showing the arrangement of essential components when performing the method according to the preferred embodiments of the present invention.

FIG. 2 is a vertical sectional view through the apparatus according to the preferred embodiment of the invention.

FIG. 3 is circuit diagram of the apparatus according to the preferred embodiment of the invention.

FIG. 4 is a schematic view of arrangement of transparent films according to the first preferred embodiment of the invention.

FIG. 5 is a schematic view of arrangement of transparent films according to the second preferred embodiment of the invention.

### DETAILED DESCRIPTION OF PREFERRED EMBODIMENTS

An explanation will be given of the method and apparatus for manufacture of pre-inked rubber stamps in accordance with the present invention based on the following embodiments.

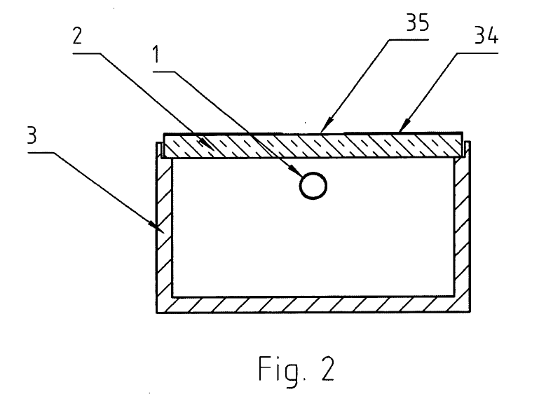

FIG. 2 shows as vertical sectional view an example of the apparatus for manufacture of pre-inked rubber stamps, comprising xenon-filled flashtube 1, flat glass cover 2 and case 3, where electronic circuit, comprising flash capacitor, trigger circuit, charging circuit and controller are accommodated. The glass cover 2 is fastened to the case 3 by adhesive. The glass cover 2 has non-transparent mask 34 with window 35.

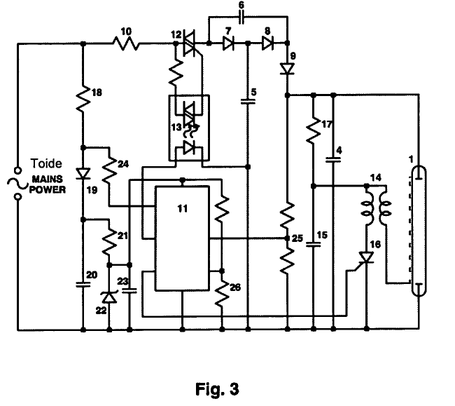

FIG. 3 shows the circuit diagram of the electronic circuit. Flash capacitor 4 is connected to flashtube main electrodes and delivers energy for the flash discharge. The flash capacitor is charged from mains power supply, using voltage multiplier on capacitors 5 and 6 and rectifies 7, 8 and 9. The charging current is limited by resistor 10 and the whole charging process is controlled by microcontroller 11, whereas the charging current is switched on and off by triac 12, coupled to controller by optocoupler 13. The trigger circuit comprises trigger coil 14, with secondary windings connected to flashtube 1 trigger electrode, and primary windings connected to trigger capacitor 15 and trigger thyristor 16, controlled by microcontroller 11. The trigger capacitor 15 is charged from flash capacitor through resistor 17. The microcontroller is powered by DC supply circuit consisting of resistor 18, rectifier 19, capacitor 20, resistor 21, Zener diode 22 and capacitor 23. The microcontroller inputs are supplied with mains power phase information by resistor 24 connection, with flash capacitor 4 voltage level information by voltage divider 25 connection and with glass cover 2 temperature information by thermistor 26 connection. As realized by the microcontroller's software, it counts successive flashes, determines the required flash capacitor's voltage, based on flash count and temperature information, controls the triac switchpoints relative to mains supply phase, and performs flash triggering by thyristor switching.

After connecting to AC mains, the microcontroller 11 is powered by the said DC supply circuit and begins its function according to its software. It determines the current temperature by measuring voltage on the thermistor 26 and derives the required voltage for the first flash. After that, it starts flash capacitor charging by switching on the triac 12 in suitable moments of AC power periods for delivering appropriate charging current. Simultaneously, it measures the voltage on the flash capacitor, by voltage divider 25. When the measured voltage reaches the required, the charging is finished and after that, when the preset time period (12 sec) is over, the microcontroller performs flash by switching on the thyristor 16. The trigger capacitor 15 was charged simultaneously with the flash capacitor through resistor 17 and now it is discharged by the thyristor 16 through trigger coil 14. The secondary winding of the trigger coil obtains high voltage impulse, that triggers the discharge in the flashtube 1.

When performing successive flashing, the glass cover temperature rises and less energy for exposition is required. The rapid temperature rise of the glass cannot be adequately detected by the thermistor 26, so the microcontroller's software determines the required voltage based not only on the temperature of the thermistor 26, but taking in the account the accumulated energy from previous flashes too.

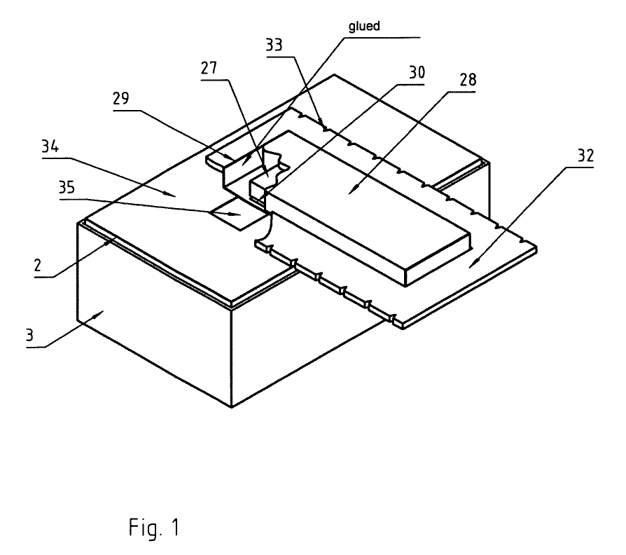

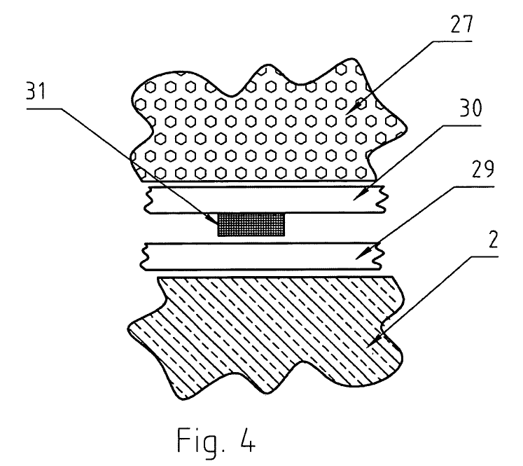

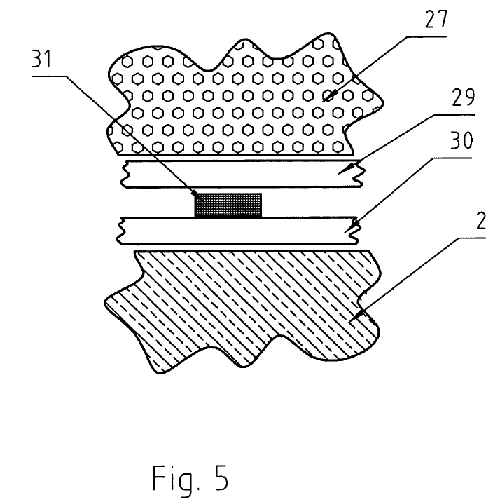

Description of the method according to the preferred embodiments is based on the FIG. 1 and FIGS. 4 and 5.

According to embodiment 1, a raw printing plate 27 is mounted in case 28. It is covered with transparent separating film 29 and transparent film 30 with non-transparent printout 31 of original stamp pattern. The separating film 29 is fastened to the case 28 by adhesive at it's turned up ends (FIG. 1). The transparent film 30 with mirror image of original pattern is inserted between the raw printing plate 27 and separating film 29, whereas the non-transparent pattern 31 (as the mirror image in this embodiment) is placed on the outer surface of the film 30.

According to embodiment 2, raw printing plate 27 is mounted in case 28. It is covered with transparent separating film 29 and transparent film 30 with non-transparent printout 31 of original stamp pattern. The separating film 29 is fastened to the case 28 by adhesive. The transparent film 30 with the original pattern is laid onto the outer surface of the separating film, whereas the non-transparent pattern 31 is placed on the inner surface of the film 30. If the pattern consist of low-melt substance (a printer dust or the like), the film 30 sticks to the separating film 29 after the first flash exposition. Otherwise, the film 30 is fastened to the film 29 by adhesive.

According to the both embodiments 1 and 2, the raw printing plate 27 is exposed by flashes using the above described apparatus. Flat non-transparent cover 32 with opening for the printing plat's case and with markings 33 is used to screen the flashlight from operator's eyes and to establish the required exposing positions of the raw printing plate. The cover 32 is laid over the flat glass cover 2 of the said apparatus with its openings one end above the window 35 and the appropriate markings 33 arranged at the edges of the glass cover 2 serving as an index. The position of the cover 32 for the first flash exposition is given on the FIG. 1. The raw printing plate 27 with case 28 and transparent films 29 and 30 is placed in the opening of the cover 32 and pressed to the glass cover 2 by hand. The apparatus is switched on and begins periodical flashing. After each flashing, the non-transparent cover 32 together with case 28, raw printing plate 27 and films 28 and 29 is transposed, whereas the next successive markings 33 are arranged at the edges of the glass 2, until the whole surface of the raw printing plat is exposed. Then the apparatus is switched off, the films 29 and 30 are thrown off from the case 28, the printing plate 27 is filled with ink by any convenient method and together with the case 28 it is fastened into the stamp mount.

1. Method of manufacturing of the pre-inked rubber stamp from thermo-plastic material, based on selective closing of surface pores of raw printing plate from porous thermo-plastic material by selective flash irradiation, comprising of
preparing of transparent (or semitransparent) thin sheet material with non-transparent original pattern of necessary stamp print-out,
pressing raw printing plate, covered with the said transparent sheet with original pattern, against flat transparent cover of a flash light source,
exposing the said raw printing plate through the said transparent sheet by several flashes, whereas the energy of the flashes is sufficient to melt and close the pores of the surface of raw printing plate on transparent areas of the original pattern,
characterised in that for adequate exposing of the entire surface area of the said raw printing plate, the raw printing plate together with the thin sheet with original pattern is transposed along the transparent cover of the flash light source between the flash expositions.

2. Method according to claim 1, characterised in that a non-transparent cover with opening for exposing is used that covers up the flat transparent cover of the flash light source.

3. Method according to claim 2, characterised in that the said non-transparent cover is supplied with markings that enable adequate transposing of the row printing plate.

4. Apparatus for manufacture of pre-inked rubber stamps, comprising of one or several gas filled flashtubes, covered by flat transparent cover, flash capacitor(s), trigger circuits, charging circuit and controller, the said flashtube(s) automatically perform(s) series flashing at certain interval, characterised in that the controller automatically decreases the successive flash energy to compensate the local temperature rising of the said transparent cover.

5. Apparatus according to claim 4, characterised in that the said flat transparent cover has a non-transparent mask with central transparent window upon the flashtube(s).
